(19) United States
(12) Patent Application Publication
(10) Pub. No.: US 2026/0264077 A1
(43) Pub. Date: Sep. 10, 2026

(54) Micro-Pumping Extraction of Fluids in Suspending Media

(71) Applicants: Cody Christopher Birkland, Seattle, WA (US); Amy Jean Swanson, Seattle, WA (US)

(72) Inventors: Cody Christopher Birkland, Seattle, WA (US); Amy Jean Swanson, Seattle, WA (US)

(73) Assignee: Ultropia Corporation, Seattle, WA (US)

(21) Appl. No.: 19/557,099

(22) Filed: Mar. 4, 2026

Related U.S. Application Data
(60) Provisional application No. 63/766,384, filed on Mar. 4, 2025.

(51) Int. Cl. B01L 3/00

(52) U.S. Cl. CPC B01L 3/50273; B01L 2400/0487

(57) ABSTRACT

A fluid extraction method is disclosed that employs a dynamically actuated porous structure to induce micro-pumping within and across a suspending medium. The system consists of a working surface coupled to an open-porosity metallic or polymeric substrate containing an array of micro-pumping chambers. Upon application of mechanical energy, such as oscillatory deformation via electromechanical actuators, localized pressure gradients are generated within the pumping layer, which drive fluid from the suspending medium into the device through capillary and adhesion forces. The pumping effect extends into the contacting medium, promoting fluid migration even at low moisture contents and overcoming osmotic, suction, and capillary retention barriers. Extracted fluid is routed into drainage, transport, or heat exchange systems, making the method compatible with a wide range of industrial applications.

### CROSS-REFERENCE TO RELATED APPLICATIONS

This application claims priority to, and the benefit of, U.S. Provisional Patent Application No. 63/766,384, filed on Mar. 4, 2025. The entire disclosure of the above-referenced application is hereby incorporated by reference in its entirety for all purposes.

### STATEMENT REGARDING FEDERALLY SPONSORED RESEARCH OR DEVELOPMENT

This invention was made with Government support under grant number 2335611 awarded by the National Science Foundation. The Government has certain rights in this invention.

### TECHNICAL FIELD

The present disclosure relates to a rapid, low energy fluid extraction technology, and specifically to a device and method utilizing micro-pumping phenomena for disassociating liquid from suspending media and transporting said fluid in a controlled manner.

### BACKGROUND ART

Fluid extraction, also referred to as dewatering or liquid-solid separation, is a critical step in a multitude of industrial, agricultural, and medical processes. The objective in these processes is to quickly and efficiently remove a fluid from a suspending medium, with the fluid, the suspending media, or both being a valuable output of the process. A few representative but not limiting examples of fluid-bearing suspending media are: muds or soils as part of mining processes, salt slurries in lithium pools, biomass and agricultural products, petrochemical mixtures, oil sands, wet linens, paper webs, blasting tumbling or cutting media, pharmaceutical products or intermediate constituents during manufacturing, chemical mixtures, and organic waste.

Industries relying on such extraction processes represent a significant fraction of the global economy. Drying processes alone account for a substantial portion of industrial energy use. Studies estimate that drying consumes around 7-15% of all industrial energy in some regions, and as much as 12-25% in developed economies. This makes drying one of the most energy-intensive operations globally.

Existing fluid extraction methods are often costly in terms of processing time, energy use, and equipment expenditures. For example, extraction equipment is often a major contributor to the setup costs of a material processing facility, the natural gas, coal, biofuel, or electricity required to run said equipment is a large portion of monthly operating costs. The long processing times end up being a bottleneck that limits the overall throughput of the facility.

For the purposes of this invention, the fluid entrained within a suspending medium is categorized by the magnitude of the physical and chemical forces acting upon the liquid molecules. The efficiency of extraction is fundamentally limited by the transition between these states, which are defined as follows:

Free or bulk fluid refers to the liquid fraction or fluid mixture that is not physically associated with the suspending media. This fluid occupies the macro-voids of the mixture and retains the physical properties of the bulk fluid, for example a standard viscosity and density. It is characterized by its ability to be removed via gravitational drainage or low-pressure mechanical displacement.

Interstitial or capillary fluid is trapped within the microscopic pores, crevices, and capillaries of the consolidated media. While not chemically bound to the surfaces, this water is held by capillary suction forces and surface tension. Traditional mechanical extraction devices, such as belt presses and centrifuges, are primarily designed to overcome these capillary forces. However, as pore diameters decrease during compression, the required pressure to displace this liquid increases exponentially, acting as a key physical limit to these processes.

Vicinal or adsorbed fluid comprises the molecular layers in immediate proximity to the solid-liquid interface. Unlike bulk fluid, vicinal fluid is structurally ordered by hydrogen bonding, Van der Waals forces, and electrostatic interactions with the solid surface. This ordering results in a structured fluid layer that exhibits a significantly higher viscosity, often two orders of magnitude greater than the bulk fluid, and a lower thermodynamic activity. Because these molecules are effectively tethered to the surface, they cannot be removed by the bulk hydraulic pressure or centrifugal forces utilized in conventional mechanical extraction.

Conventional technologies for fluid removal include evaporative thermal drying, mechanical pressing, centrifugation, vacuum filtration, and combinations thereof. Thermal drying is widely deployed because it can reach low final moisture contents, but it is fundamentally energy-intensive because water removal requires heating the fluid and supplying the latent heat of vaporization (2,260 kJ/kg for water). Additionally, evaporation is time intensive, applied heat can damage the suspending material which may be a valuable output of the extraction process, and the high heats used often lead to fires. Additionally, if the extracted fluid is to be recovered as a valuable output, the hot exhaust air must be passed through a condenser or equivalent system, further adding time and energy expenditures and additional equipment.

Mechanical dewatering methods such as centrifugation and pressing reduce energy consumption and processing time by lowering the amount of water that must be evaporated; however, mechanical methods frequently encounter diminishing returns as moisture content decreases. At lower moisture levels, liquids are increasingly retained by pore-scale capillary forces, interfacial adhesion, and medium-specific physicochemical interactions. As a result, additional applied static pressure may yield limited incremental liquid removal and can cause rewetting, compaction, or damage to fragile suspending media, leading to reduced throughput, added processing steps, and higher operating cost.

Often only a portion of the fluid can be removed by pressure before the process becomes ineffective. When the media is subjected to continuous mechanical force, fluid transport is limited by diffusion rates, which are greatly limited with low moisture contents. There are practical limitations to how much pressure a machine may supply by pressing or centrifugation, and these processes are fundamentally self-limiting, as higher pressures increasingly close the bulk flow paths required for fluid flow. Consequently, mechanical extraction can only be applied with limited effectiveness, frequently requiring subsequent processing steps, such as evaporative extraction. For example, even after high-pressure filtration or pressing, cakes of material can retain about 45-60% moisture. Similarly, spun-dry textiles commonly still hold around 50% of their weight in water after maximum centrifuge extraction.

Other extraction methods, such as chemical and gas extraction, are complex, add additional steps, and can create potentially harmful byproducts.

To address these issues, ultrasound-assisted approaches have been proposed. In many implementations, moisture removal is associated with atomization or aerosol (“cold mist”) generation in response to high-frequency oscillation, capillary surface waves, and related interfacial instabilities. While such methods can enhance liquid removal rates in media with high moisture content, the extraction falls off greatly as the amount of free liquid is reduced. The acoustic wave propagation foundational to these methods is greatly hampered by viscous and non-newtonian fluids such as slurries. Furthermore, aerosol generation may be undesirable for many applications because it can complicate liquid capture, increase contamination risk, and require additional air handling or condensation equipment.

U.S. Pat. No. 10,520,252B2 describes a mesh transducer that uses ultrasound to induce Faraday waves in surface water to drive the formation of atomized water droplets. Such methods are reliant on the presence of free or interstitial water to create such waves, which is a key limitation for practical use, as widely deployed presses and centrifuges are capable of removing this form of liquid rapidly and with lower costs and higher reliability. Likewise, said mesh transducers have been shown to exhibit a dramatic decrease in extraction performance at even moderate moisture levels of 80-100% by weight as per Oak Ridge National Lab research, indicating a transition to friction based evaporative drying. As a result, these devices have not seen widespread adoption.

Accordingly, there remains a need for improved fluid extraction technologies that (i) provide rapid removal at low moisture contents where static pressing and atomization are limited by capillary and physicochemical retention, (ii) reduce energy consumption and processing time relative to evaporation-based drying, (iii) avoid atomization/aerosolization and instead enable recovery of extracted liquid in bulk form, (iv) enable use with slurries and viscous fluids, and (v) operate with manageable mechanical stress on the suspending medium.

### DISCLOSURE OF INVENTION

The present invention is an extraction method and device utilizing micro-pumping and surface effects, such as adhesion, capillary action, and Van der Waals forces, to pull fluid into a micropump structure, where it can be coalesced into a greater total volume of liquid, where it can then be removed through additional pumping or drainage. This approach removes the requirement to subject the bulk volume of suspending media to pressure, while also improving the rate of extraction and energy efficiency compared to existing processes.

This process is enhanced by the application of localized, cyclic pressure fields to induce pumping action at the interface to or within a porous suspending medium, such as within the fibers of a fabric or within pores of a particulate bed, so as to actively transport retained fluid toward the micropump rather than relying on diffusion-limited migration or capillary waves. This enables extraction at low moisture content by leveraging the attractive forces within the suspending media to transport fluid progressively.

### BRIEF DESCRIPTION OF THE DRAWINGS

FIG. 1: A sectional view of an embodiment of the process, where surface effects draw fluid from the suspending medium onto the working surface.

FIG. 2: A sectional view of an embodiment of the process, showing fluid being pumped beyond the surface of the device into the micro-pumping chambers as a result of mechanical deformation.

FIG. 3: A sectional view of an embodiment of the process, showing fluid being expelled from the micro-pumping chambers by mechanical deformation, where the fluid then moves into a bulk collection area connected to a drain.

### MODE(S) FOR CARRYING OUT THE INVENTION

The present disclosure describes systems and methods for extracting a fluid from a suspending medium using a working surface coupled to a distributed micro-pumping structure. The suspending medium may be any porous, fibrous, particulate, or composite medium that retains a fluid, including textiles, paper/fiber webs, biomass, soils, tailings, filter cakes, slurries, gels, pastes, and mixtures containing liquids and solids. The working surface contacts the suspending medium and provides distributed pores and/or channels that admit fluid into the micro-pumping structure. Cyclic mechanical deformation of the micro-pumping structure induces oscillatory pressure gradients and volume changes that transport admitted liquid away from the working surface toward a collection region and manifold for discharge as a bulk fluid.

Conventional micropumps are commonly used throughout medical and scientific industries. These micropumps have historically consisted of discrete actuators and pumping chambers, where fluid is transported in and out of the pump through distinct inlets, outlets, and manifolds. The present invention departs from this approach by making a layer of a plurality of micro-pumping chambers that are actuated by a common mechanical input source, allowing bulk fluid transport to occur based on the interaction of the chamber geometry and the fluid as the micropumps are deformed under mechanical action. Additionally, the micro-pumping chambers are fluidically coupled to a working surface that provides distributed channels or pores to allow fluid into the micro-pumping chambers. This design allows the working surface to fluidically and mechanically couple to a suspending medium that contains fluid to be extracted as dictated by the application.

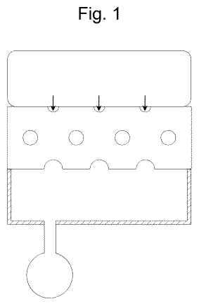

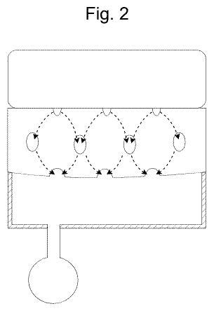

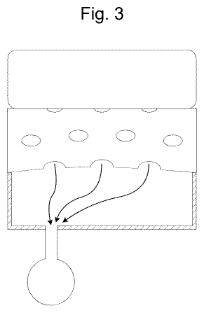

As used herein, “working surface” refers to a surface region configured to contact the suspending medium and to preferentially wet with the fluid to be extracted. In embodiments, the working surface comprises a porous or micro-channeled layer including a plurality of inlet pores and/or channels distributed across an area intended to contact the suspending medium (FIG. 1). “Micro-pumping chambers” refer to deformable void volumes, throats, pores, channels, or combinations thereof, that change internal volume and/or hydraulic resistance under applied mechanical deformation to generate net transport of the fluid within the device (FIG. 2). “Pumping layer” refers to a layer comprising a plurality of micro-pumping chambers and interconnections configured to transport, coalesce, and deliver liquid from the working surface to a collection region or manifold (FIG. 3). “Collection region” includes one or more plenums, manifolds, reservoirs, or drains where extracted liquid accumulates and is discharged as bulk liquid by gravity, suction, or auxiliary pumping.

The micro-pumping chambers may be integrated into the same material as the working surface, or they may be made to be separate for ease of manufacture or for optimization of performance. Metals are suitable for these structures, as well as polymers, or in some cases other materials including composites, weaves, and ceramics. The working surface may be created, for example by cutting into the base material, forming through stamping or molding, or application through coatings, photolithography, or electrodeposition. 3D printed, sintered, dealloyed nanoporous metals, or otherwise bonded metallic structures have been utilized to create an effective porous pumping layer. Surface chemistry may be modified to tune wettability and selectivity, including coatings, plating, oxidation, plasma treatment, and grafted surface layers. Fabrication methods include machining, stamping, molding, embossing, laser ablation, lithographic patterning, etching, electrodeposition, lamination of patterned layers, diffusion bonding, and combinations thereof.

In operation, the working surface is brought into contact with the suspending medium. The working surface may be selected and/or surface-treated to promote association of the target fluid through wetting and surface forces, including adhesion and capillary action, thereby drawing liquid from pores or fibers of the suspending medium into the distributed inlet pores/channels of the working surface (FIG. 1). Controlled roughness, microchannels, hierarchical porosity, or patterned grooves may be used to increase effective area and hydrophilicity, and to provide fluid access to the inlets. In some embodiments, the working surface provides passive priming of the micro-pumping chambers by capillary admission of liquid prior to or during actuation. In practice, the hydrophilicity of said working surface, as measured by contact angle, may be less than 60°, but preferably less than 25°. The surface tension of water is typically stated as 72 mN/m at room temperature, so the surface energy of the pores and channels in embodiments that are extracting a primarily aqueous fluid is made to be greater than 70 mN/m, and preferentially above 200 mN/m. The surface energy is dictated by the material selection, surface treatment, or a combination of both, as is typical for hydrophilic surface engineering.

The micro-pumping action is necessary for the process, as it ensures fluid movement along and beyond the working surface (FIG. 2), allowing the extraction process to continue while also accelerating fluid transport through cohesion, capillary action, and surface tension. Micro-pumping also drives fluid to other parts of the system (FIG. 3), where the fluid can be used for heat exchange, such as cooling or heating of system components, and ultimately drained, expelled mechanically, or pumped away by bulk pumping process, such as with conventional diaphragm, rotary, or vacuum pumps.

The pumping layer comprises a plurality of micro-pumping chambers fluidically coupled to the working surface. A mechanical input source cyclically deforms at least a portion of the working surface and/or the pumping layer, thereby periodically changing internal volume, channel geometry, hydraulic resistance, and/or local curvature of fluid interfaces in the micro-pumping chambers. The chambers and interconnected with channels are made to deform by at least 5% of their internal volume when subjected to the applied mechanical input force. This deformation is induced by several possible mechanisms, which depend on the method of construction, and include compression of the bulk material, buckling of supports within the lattice, and deformation of the pores and channels withing the micropump network. The cyclic deformation generates an oscillatory pressure field and pressure gradients within the admitted fluid. These pressure gradients, made to be 0.1-20 MPa, combined with the capillary action, surface adhesion, and Van der Waals forces produced by the hydrophilic micropores and channels on the working surface and within the pumping layer, act to transfer fluid throughout the structure in a directional manner. This principle is applied to direct fluid throughout the structure as well as coalesce the fluid into additional chambers as needed, where the micro-pumping process can be continued (FIG. 2).

In embodiments, the pumping layer is configured to coalesce admitted fluid by directing flow from smaller inlets or pores into progressively larger micro-pumping chambers or conduits in the direction of transport to reduce flow resistance and enable higher bulk throughput (FIG. 3). In embodiments, the extracted fluid remains in the liquid phase throughout transport within the device and is collected and discharged as bulk fluid from a manifold/drain, rather than being intentionally vaporized.

In this manner, an interconnected lattice of micropumps can be created, as to rapidly and efficiently guide fluid from the working surface into bulk collection chambers or towards a surface or region separate from the suspending media. The sizing of these components, such as the micro-pumping chambers, is dependent on the specific process. The micro-pumping chambers can range from a few microns to several millimeters or larger, depending on factors such as the viscosity of the fluid, the presence of suspension in the fluid, the rate of transfer, and the properties of the suspending media. On the working surface, for instance, the pore size is selected to permit the transmission of fluid while keeping the suspending media out of the pumping structure. For fine suspending media, such as silica sand, chamber sizes of 10 microns or less are often desirable. The size and geometry of such features can vary throughout the devices, for instance, the micro-pumping chambers can progressively increase in size in the direction of fluid flow, serving to coalesce the fluid and increase the extraction rate, without compromising the effectiveness of the working surface and inlets. For chambers and capillaries near and on the working surface, the characteristic length of these features should be less than 500 μm to ensure a capillary effect, but not generally less than 1 μm as the fluidic resistance becomes too high for most applications. Pores and channels further from the working surface may be equivalent in characteristic length, although increased performance is often gained by enlarging these channels to 500 μm-1 mm or more, as this presents less hydraulic resistance to the flow being driven by the upstream pumping chambers and overall inertial acceleration of the pumping layer.

As the pumping process in this method can be highly dynamic, the viscosity of the fluid needs to be considered. As per the Lucas-Washburn equation, the distance a parcel of fluid travels through the pumping structure is dictated by the dynamic viscosity and surface tension of the fluid, both dictated by the application. For a selected pore size and a minimized contact angle within the channels and pores of the structure, the duration of fluid migration over a given length is fixed. By applying dynamic pumping to the structure, fluid parcels subject to the resulting pressure gradients are made to accelerate beyond the rate of capillary wicking.

The micro-pumping process is dependent on mechanical deformation of the pumping structure, and the forces involved may be made to transfer through the working surface to the suspending media in a manner that further enhances the disassociation of fluid from the media. Inducing rapid mechanical deformation of the working surface transfers that displacement to the suspending medium, creating compressive forces that reduce the available surface area of capillary pores. Rapid deformation of the pumping structure and working surface, with amplitudes of 1-80 μm and accelerations as high as 5×10\hat{ }7 m/s², will induce localized megapascal-scale compression in the suspending medium, shrinking the pore radii within the media by as much as complete closure, further expelling water and driving fluid migration towards the working surface. Additionally, the rapid accelerations induce inertially driven fluid migration towards the working surface.

In the present invention, rapid oscillatory deformation drives localized fluid transport within the pumping layer, which may, as a result of mechanical and fluidic coupling, extend into the suspending media by several centimeters, effectively incorporating the media into the pumping structure temporarily. Therefore, the pumping structure within this method and device may refer to that of the device, or the device in combination with the suspending media while the media is in intimate contact with the device during the extraction period.

The extraction period may be long, on the order of tens of minutes, or very brief, fractions of a millisecond, depending on the application and suspending media. Also, the media may be repeatedly treated with many short periods, for example, as a slurry is mixed within a containing vessel and regions of the suspending media are periodically brought into contact with the active micro-pumping devices.

The aforementioned applied pressures and localized deformations of the pumping layer and suspending media are directed to reduce and close internal pores and mechanically dislodge surface bound fluid by means of inter-particle impaction and shear. This reduces the available bonding sites for fluids, which are normally retained by various mechanisms including Van der Walls forces, electrostatic forces, and hydrogen bonds. This reduction in bonding sites and surface bound fluid also induces a pumping effect: by reducing the availability of bonding sites, excess fluid is dispersed from the region, and because the deformation is localized, a preferential flow direction is created as the fluid moves to regions with greater availability of bonding sites. This can be made to occur in both the suspending media and the pumping layer, and when properly designed for the application, the fluid is made to transfer from the suspending media, into the pumping layer, and through to the collection manifold.

The combination of capillary force, surface-bonded fluid migration, and a localized pressure field contribute to creating a higher differential osmotic pressure, on the order of tens of megapascals, than is achievable with centrifuge or press induced pressure, or with ultrasound-induced Faraday waves. This effect is greatly beneficial in removing deeply entrained interstitial and vicinal fluid bound within the suspending media via hydrogen bonding or electrostatic forces. This greatly improves mechanical extraction at low moisture contents versus existing extraction methods, making the present invention practical for industrial applications. See the Experimental Results section for data on micro pumping extraction performance at low moisture contents.

In general, oscillating pumps require a means to limit the backflow of liquid towards the intake direction, as this backflow reduces the net fluid flow and is therefore detrimental to pump performance and efficiency. In the present invention, directionality of the fluid flow may be enhanced by the geometry of the pump structures. Specifically, the chambers may incorporate structural features which passively pass fluid in one direction preferentially, such as by providing asymmetric chamber geometries, tapered pores or throats, nozzle-diffuser elements, fluidic diodes, or other passive rectification features used in microfluidics. Alternatively, the pumping chamber geometry may be dynamically modulated by applied mechanical energy such that the path of fluid flow presents less hydraulic resistance, or in some cases greater fluidic attraction, in the direction of the outlet during the expulsion phase, and greater resistance in the reverse direction during an intake phase. Directionality may also be enhanced by the application of additional mechanisms, including inertially driven flow or a superimposed pressure gradient created through forced air, vacuum, or traditional pumping, in some embodiments.

This method may be embodied, non-exclusively, as a single device, consisting of a plurality of micropumps adjacent to a working surface designed to contact the suspending medium. This device includes, for example, a mechanical structure, such as a thin plate, securely attached to the micro-pumping layer which is designed to allow for and control the deformation of the micropumps upon application of mechanical energy. This mechanical energy is directed to the mechanical structure through linkages or transfer elements such as cams or levers, or could be applied directly through, for example, an electromechanical actuator mounted directly to the mechanical structure of the micropump device. Pumping action may be induced by a gradual application of mechanical force, such as from a hydraulic press or centrifuge for example, or preferentially by rapid application of mechanical force, such as beaters, cams, vibratory motors, or electromechanical actuators including piezoelectric and electromagnetic devices. Said mechanical force shall be designed to induce the effective pressures in the pumping layer, working surface, and suspending media at the target pressures mentioned previously. For oscillatory operation the actuation may be continuous, pulsed, or burst-mode, with the actuation rate selected based on the medium and desired throughput, and can range from gradual application at low frequencies (including sub-kHz) through high-frequency MHz vibrations, in the range of 20 kHz-4 MHz, and preferentially between 40-280 kHz. Step-applied loading may be used to apply the actuating force suddenly, with rise times ranging from 0.1 μs to several milliseconds, and then cyclically reapplied.

In embodiments, extracted liquid is delivered to a collection region coupled to a drain and may be removed by gravity drainage and/or by applying negative pressure at the manifold. Forced airflow and/or a vacuum source may be used to sustain unidirectional drainage of bulk liquid, to remove accumulated liquid, and/or to assist in clearing pores. In embodiments, extracted liquid may be routed past mechanical or electrical components for thermal management or heat recovery prior to discharge.

Other enhancements include self-priming features implemented into the micropumps, such as capillary wicking or inertial fluid transport into the pumping chambers. The disclosed micro-pumping method may also be used in conjunction with existing extraction methods for added performance, such as compression, centrifuge, evaporation, vacuum, filtering, shaking, stirring, bulk pumping, and airflow to name a few. The micro-pumping chambers can also be implemented with self-cleaning or clearing features, such as any combination of pressurized air, liquid jets, suction forces, or vibrational energy. For example, pressurized air of typical industrial levels, for example 10-120 PSI, may be applied in an alternating direction between the inlet and outlet to clear any accumulated debris. In another embodiment, the structure can be made to vibrate in the kHz range with displacements between 50 nm to 10 μm to dislodge accumulated debris from the surface and internal structures, including the use of the micro-pumping action itself as a self-cleaning mechanism.

This method may also be embodied, non-exclusively, as many such devices arranged to be adjacent to each other as to increase the amount of the suspending medium that is treated. These devices may include many independent mechanically actuated structures, or may include one or more common mechanically actuated structures. The energy source can be linked to many devices mechanically through linkages or structural features. One or more mechanical actuators generating said energy can be independently powered or powered as part of an interconnected network.

Devices may be incorporated into existing material handling equipment, including bags, bladders, pipes, drums, containers, expellers, presses, and conveyors, filtration housings, pipes, and removable inserts configured to contact the suspending medium during processing. Additionally, the ability to configure the micro-pumping devices in various forms will allow for novel system designs beyond existing material handling processes.

### Best Mode for Carrying Out the Invention

Many other embodiments may be imagined based on the principles outlined in this disclosure, so this description can not provide an exhaustive list of embodiments. In one non-limiting embodiment, a best mode for implementing the present invention is as follows: A working surface composed of a open-porosity metallic foam, is patterned with a rectilinear grid of microchannels, 0.1-100 microns in width across their cross-section, but preferably less than 10 microns, with pores of similar diameter at the vertices of the network. Said pores-which are preferentially made to be densely distributed across the working surface, with a spacing of 10 microns to several millimeters for certain applications, but may be as close as 1 micron-extend into the pumping layer. The pumping layer in this embodiment may be manufactured from a sintered powder, dealloyed metal, or alternatively may be 3D printed to achieve an equivalent network of chambers, surface channels and pores, and capillaries. In this embodiment, the lattice of pores extends down into a pattered network of slightly larger chambers that are structurally designed to buckle upon the application of the distributed mechanical force that is applied to induce pumping. The rapidly applied mechanical force induces several effects: The working surface is directed upwards rapidly into the medium, dispelling water through localized inertial action and compression which induces the aforementioned pumping effect. Consequently, the working surface is wetted by the displaced fluid, which is drawn into the channels and pores. Buckling of these chambers forces the fluid to be expelled locally, transferring the volume into adjacent chambers through the capillaries between pores.

As the applied force is removed, the chambers recover to their original shape, increasing their internal volume, and as a result, draw liquid in from the network of pores. The rate of the chamber recovery is made to exceed that of the medium, such that the fluid is preferentially drawn into the chamber and is prevented in majority from being reabsorbed by the suspending medium. This rate, in this example operating point, may be on the order of 120,000 cycles per second, with a peak displacement of 10 microns or more, effectively inducing surface accelerations of 4×10\hat{ }6 m/s². This deformation is made possible in this embodiment by means of a piezoelectric actuator mechanically coupled to the pumping layer via a epoxy-bonded metallic plate, which also serves to isolate the actuator from moisture.

In this example of a best mode for the invention, a slight vacuum of 900 mBar absolute is applied to the backside of the porous structure at a manifold where the pore network is joined, as to remove the accumulated bulk liquid and ensure that the net flow is unidirectional.

Overall, this example best mode is presented as a flat layered structure, with the working surface in contact with the media to be treated, and the pumping layer incorporated with and adjacent to the working surface. The pumping layer, built as a network of densely interconnected chambers, feeds into a manifold for collection. An airflow system is connected to this manifold to apply a vacuum to the outlet side of the pumping layer, such to remove bulk fluid and aid in the extraction process. The mechanical force is supplied by a piezo element bonded within an enclosed metallic structure mechanically integrated into the pumping layer and manifold, such that the electrical connections are isolated from moisture, but the force supplied by the element is transferred directly into the pumping layer. An added benefit of this arrangement is that the fluid can be made to pass over the metallic enclosure, providing a cooling effect to the piezo element if needed.

### Experimental Results

Experimental evaluation of an electromechanically actuated open-porosity metal substrate demonstrated that a device utilizing the described micro-pumping method extracts fluid from suspending media with significantly lower energy consumption and at moisture levels beyond the capabilities of traditional processes. In this example, a textile dewatering application was evaluated.

Several experimental trials were conducted for each of three representative textile classes: 100% cotton, 100% polyester, and a 50/50 cotton-polyester blend. In each case, the system achieved complete removal (<5%) of free moisture from fully saturated test cloth without reliance on thermal evaporation. For 100% cotton, a dry fabric mass of 273 mg was used, from which 292 mg of water was extracted in 45 seconds, corresponding to a scaled extraction rate of 649 mL/min when normalized to a pound of fabric. For 100% polyester, with a dry fabric mass of 224 mg, 224 mg of water was removed in 30 seconds, yielding a higher scaled extraction rate of 907 mL/min per pound of fabric. The increased extraction rate observed for polyester is understood to be consistent with weaker water-fiber binding in hydrophobic textiles. The 50/50 cotton-polyester blend, with a dry fabric mass of 152 mg, exhibited comparable results to pure cotton, with 142 mg of water extracted in 39 seconds, corresponding to 652 mL/min per pound fabric. Effective fluid removal was observed even at low moisture contents (10-15%), overcoming the limitations of capillary and osmotic or suction retention that inhibit centrifugal or press-based techniques. Across representative conditions, specific energy was 46% of an evaporative baseline for a gas-fired thermal dryer. Higher energy efficiency is observed at lower extraction rates.

### INDUSTRIAL APPLICABILITY

The micro-pumping extraction device and method described herein are industrially applicable to the removal or recovery of fluids from suspending media in a wide variety of processing environments, including textile and fibrous web dewatering, solid-liquid separation of slurries and particulate beds, biomass processing, chemical and pharmaceutical manufacturing, and environmental and mining operations.

In textile dewatering embodiments, the method is applicable to textiles at residual moisture levels commonly produced by conventional mechanical extraction prior to thermal drying, for example below 60% moisture by weight, where extraction rates of above 400 ml/min per kg fabric must be maintained.

The invention provides a technical solution for rapid, low energy, non-thermal fluid extraction by using a working surface and distributed micro pumping structure that couples to the medium, draws liquid to the working surface by active and passive phenomena, and transports the liquid to a collection region or manifold for discharge as bulk liquid.

Specifically, the invention utilizes the dynamically induced, distributed micro-pumping process to provide a technical solution for efficient, high-speed extraction of fluid from suspending media, exhibiting high extraction rates at low moisture levels not achievable with other mechanical extraction methods. The micro-pumping devices described can be manufactured using standard techniques including lithographic etching, 3D printing, lamination, sintering, and machining, allowing for scalable production.

1. A method of fluid extraction from a suspending medium comprising the acts of:
a. providing one or more working surfaces that are configured to contact the suspending media, where the porous working surface comprises a plurality of inlet pores and/or surface microchannels distributed across an area configured to contact the suspending medium and surface characteristics promote fluid association and separation from the suspending medium;
b. providing one or more micro-pumping structures, defining a plurality of deformable micro-pumping chambers in fluid communication with one or more porous working surfaces;
c. using a micro-pumping effect to transport fluid directionally from the suspending media to the working surface(s), and ultimately through a pumping layer to a collection region;
d. inducing said micro-pumping by the application of dynamic mechanical energy.

2. The method of claim 1 where micro-pumping, induced in the suspending medium by coupling the mechanical deformation of the working surface, drives fluid migration towards the working surface, effectively incorporating a portion or all of the medium into the micro-pumping layer during the treatment period.

3. The method of claim 1, wherein cyclic deformation is produced by an actuator selected from a piezoelectric actuator, an electromagnetic actuator, a voice-coil actuator, a motor-driven cam, an eccentric mass vibrator, a linkage, a pushrod, or a gear train.

4. The method of claim 1 where micro-pumping is induced in a pumping layer proximal to the working surface, comprised of a network of interconnected pores in a lattice structure.

5. The method of claim 1 where said pumping layer is comprised of one or more intermediate layers patterned with channels to control fluid motion.

6. The method of claim 1 where the fluid to be extracted remains in a liquid state throughout the micro-pumping process, and the fluid may be a liquid, a chemical solution, a solid contained in liquid suspension, or a liquid mixture or colloid.

7. The method of claim 1, where the micro-pumping action is combined with externally supplied energy for enhanced fluid transport, such as compression, centrifuge, evaporation, filtering, shaking, stirring, bulk pumping, externally applied vacuum, forced air pressure, or any combination thereof.

8. The method of claim 1, where the micro-pumping action incorporates at least one self-priming or self-cleaning feature.

9. The method of claim 1, where fluid extracted is directed such that it provides a heat-exchange effect to mechanical and electrical parts of the system.

10. The method of claim 1, where two or more micro-pumping devices are arranged adjacent to treat a larger region of the suspending medium.

11. A device for fluid extraction from a suspending medium comprising:
a. one or more working surfaces that are made to contact the suspending medium and to admit the fluid into an interconnected pore network, where geometry and material properties of said working surface(s) promote fluid association and separation from the suspending medium;
b. a micro-pumping structure defining a plurality of deformable micro-pumping chambers in fluid communication with the interconnected pore network of the working surface;
c. micro-pumping is induced to transport fluid directionally from the suspending media to the working surface(s), and ultimately through a pumping layer incorporated in the device to a collection region;
d. inducing said micro-pumping by the application of dynamic mechanical energy.

12. The device of claim 11 the mechanical energy is made to transfer to the suspending media to induce micro-pumping, driving fluid migration towards the working surface, effectively incorporating a portion or all of the medium into the micro-pumping layer during the treatment period.

13. The device of claim 11, wherein cyclic deformation is produced by an actuator selected from a piezoelectric actuator, an electromagnetic actuator, a voice-coil actuator, a motor-driven cam, an eccentric mass vibrator, a linkage, a pushrod, or a gear train.

14. The device of claim 11 where micro-pumping is induced in a pumping layer proximal to the working surface, comprised of a network of interconnected pores in a lattice structure.

15. The device of claim 11, where said pumping layer is comprised of one or more intermediate layers patterned with channels to control fluid motion.

16. The device of claim 11, wherein the micro-pumping chambers comprise a backflow-reducing element selected from a tapered throat, a diffuser-nozzle element, a fluidic diode or buckling structures having a geometry that changes internal volume during cyclic deformation.

17. The device of claim 11, wherein the device is operable with cyclic deformation frequencies from 0.1 Hz to 4 MHz.

18. The device of claim 11 where fluid extracted by the micro-pumping action is directed such that it provides a heat-exchange effect to other mechanical and electrical parts of the system.

19. The device of claim 11, where the structure and resulting mode of operation incorporates at least one self-priming or self-cleaning feature.

20. The device of claim 11, where two or more micro-pumping devices are incorporated into a single structure to induce extraction in a larger region of the suspending medium.
